(19) United States
(12) Patent Application Publication
(10) Pub. No.: US 2024/0357355 A1
(43) Pub. Date: Oct. 24, 2024

(54) AKMA KEY DIVERSITY FOR MULTIPLE APPLICATIONS IN UE

(71) Applicant: TELEFONAKTIEBOLAGET LM ERICSSON (PUBL), STOCKHOLM (SE)

(72) Inventors: Ferhat Karakoc, ISTANBUL (TR); Cheng Wang, SHANGHAI (CN); David CASTELLANOS ZAMORA, MADRID (ES); Vlasios Tsiatsis, STOCKHOLM (SE)

(21) Appl. No.: 18/682,866

(22) PCT Filed: Aug. 9, 2022
(86) PCT No.: PCT/IB2022/057434

§ 371 Date: Feb. 9, 2024

(30) Foreign Application Priority Data
Aug. 9, 2021 (WO) PCT/CN2021/111557

(51) Int. Cl. H04W 12/069; H04L 65/1069; H04W 12/041

(52) U.S. Cl. CPC H04W 12/069; H04L 65/1069; H04W 12/041

(57) ABSTRACT

Systems and methods for enabling Authentication and Key Management for Applications (AKMA) key diversity for multiple applications are disclosed herein. In one embodiment, an AKMA client of a wireless device determines a root key (KAKMA) and an AKMA key identifier (A-KID) based on primary authentication with a telecommunications network. The AKMA client receives an application identifier (APP-ID) and an application function (AF) identifier (AF-ID) from an application of the wireless device. The AKMA client verifies APP-ID, and verifies that the application is entitled to use AF-ID. If successful, an application key (KAPP) is derived based on KAKMA. AF-ID, and APP-ID. Optionally, the AKMA client encrypts APP-ID and outputs A-KID. KAPP, and the encrypted APP-ID to the application, and the application sends a session establishment request to an AF, the session establishment request comprising A-KID and the encrypted APP-ID.

### RELATED APPLICATIONS

This application claims the benefit of international patent application serial number PCT/CN2021/111557, filed on Aug. 9, 2021, the disclosure of which is hereby incorporated herein by reference in its entirety.

### TECHNICAL FIELD

The present disclosure relates to techniques for authentication and key management for applications in User Equipment (UE) devices.

### BACKGROUND

The Authentication and Key Management for Applications (AKMA) feature introduced in Third Generation Partnership Project (3GPP) Technical Specification (TS) 33.535 provides a mechanism to support authentication and key management aspects for applications based on subscription credential(s) in Fifth Generation (5G) system. According to the feature, the network and the User Equipment (UE) derives a K_{AKMA} key and an AKMA Key Identifier (A-KID) as well as a K_{AF} key where the K_{AF} is used to support of the security of the communication between the UE and an AF (Application Function). The A-KID is an AKMA Key Identifier which identifies the root key (i.e., K_{AKMA}) which is used to derive K_{AF}. The A-KID comprises an A-TID (AKMA Temporary UE Identifier) and routing information related to the home network of the UE. When the UE wants to use this feature, the UE may construct the key, K_{AF}, and the key identifier, A-KID, and sends the A-KID to the AF. The AF can be located in the network or outside. The AF requests the K_{AF} for the A-KID from an AKMA Anchor Function (AAnF) by sending the A-KID to the AAnF via a Network Exposure Function (NEF) when the AF is located outside the operator's network or directly when the AF is located inside the operator's network. After the authentication of the AF by the network, the AAnF sends the corresponding K_{AF} to the AF, possibly via the NEF. Thereby the shared key material K_{AF} is available in the UE and the AF to support the security of the communication between them.

Some requirements on the UE are stated as follows in 3GPP TS 33.535 version 17.6.0:

| | |
|---|---|
| 4.4.3 | Requirements on the UE |

The requirements on the UE are:

| | |
|---|---|
| - | Applications on the UE shall not be able to get access to K_{AKMA}, |
| - | An application on the UE shall only get the K_{AF} keys related to specific |

AF_IDs (i.e., FQDN and Ua* protocol identifier combinations) that the application is
authorized to get,

| | |
|---|---|
| - | An application on the UE shall not be able to get access to the K_{AF} keys that |

belong to other applications.

| | |
|---|---|
| NOTE: | How these requirements are satisfied is out of scope of 3GPP. |

Starting from Rel-17, there is a study on Security Aspects of Enhancement of Support for Edge Computing in Fifth Generation Core (5GC). FIG. 1 shows a system diagram showing application servers, application clients, network functions of 3GPP networks from 3GPP TS 23.558. In FIG. 1, the Application Client and/or the Edge Enabler Client (EEC) within the UE block may be referred to generally herein as an “end user,” a “user client,” and/or an “application on the UE.” The Edge Application Server (EAS), the Edge Enabler Server (EES), and/or the Edge Configuration Server (ECS) of FIG. 1 may be referred to generally herein as an “application server (AS)” and/or an “application function (AF).”

AF(s) can be deployed by a Mobile Network Operator (MNO), by an Edge Computing Service Provider (ECSP), and/or by an Application Service Provider (ASP). Note that not all 3GPP network functions (NFs) are in FIG. 1. The NFs that are relevant to this disclosure are the Unified Data Management (UDM), the Network Exposure Function (NEF), and the AAnF, as shown in the 3GPP network box.

Under the study on Security Aspects of Enhancement of Support for Edge Computing in 5GC, it is required to provide solutions for the authentication of EEC on the UE towards the ECS and the EES. One possible solution is the usage of AKMA. There are some solutions depending on AKMA in the study technical report (3GPP TR 33.839). One of the solutions (solution #28) in the 3GPP TR proposes the following steps:

| 6.28 | Solution #28: Authentication between EEC and ECS | |
|---|---|---|
| | based on AKMA | |
| 6.28.1 | Introduction | |
| | This solution addressed key issue#2 Authentication and Authorization between EEC | |
| | and ECS. | |
| | This solution proposes the authentication between EEC (Edge Enabler Client) and ECS | |
| | (Edge Configuration Server) based on AKMA. To be more specific, it is proposed to use | |
| | the K_{AKMA} derived from the AKMA procedure as the trust root to perform the | |
| | authentication between EEC and ECS. | |
| | It is assumed in this solution that ECS is located outside of the MNO's network. | |
| 6.28.2 | Solution details | |
| 6.28.2.1 | Procedure | |
| | [Figure 2 reproduces Figure 6.28.2.1-1, showing authentication between the EEC and | |
| | ECS based on AKMA] | |
| | The authentication procedure details are as following: | |
| | Step 0: UE performs primary authentication with the network. Then K_{AUSF} is shared | |
| | between UE and AUSF in Home network. | |
| | Step 1.1: UE generates K_{AKMA} and A-KID following AKMA procedure in TS 33.535 and | |
| | stores them securely. | |
| | Step 1.2: AAnF generates K_{AKMA} and A-KID following AKMA procedure in TS 33.535 and | |
| | stores them securely. | |
| | Step 2: Every EEC in this UE fetches the K_{AKMA} and generates K_{edge} from K_{AKMA} and EEC | |
| | ID. | |
| | | NOTE: In this way, there will be one K_{AKMA} and multiple K_{edge} in every UE. |
| | Step 3: Every EEC computes MAC_{EEC} using the K_{edge} and EEC ID. | |
| | Step 4: UE sends Application Registration request (EEC ID, MAC_{EEC}, A-KID) to ECS. | |
| | Step 5: ECS sends Authentication verification (EEC ID, MAC_{EEC}, A-KID) to AAnF for | |
| | verification. | |
| | Step 6: AAnF retrieves K_{AKMA} using A-KID and calculates K_{edge} using K_{AKMA} and EEC ID, | |
| | then verify MAC_{EEC} using the (K_{edge} and EEC ID). | |
| | Step 7: If AAnF verification success, then AAnF sends Authentication verification | |
| | response(success) back to ECS, otherwise, AAnF sends Authentication verification | |
| | response(fail) to ECS. | |
| | Step 8: Based on the verification results, ECS decides whether to accept or reject the | |
| | authentication request, and sends Authentication Request accept/rejection to EEC in | |
| | the UE. | |
| | | Editor's Note: It is FFS how EEC ID is authenticated. |
| | | Editor's Note: It is FFS whether ECS could perform the authentication instead |
| | of AAnF. | |
| | 6.28.2.2 Derivation of K_{edge} and K_{edge} ID | |
| | K_{edge} is generated using KDF defined in Annex B.2.0 of TS 33.220 [8]. When deriving a | |
| | K_{edge} from K_{AKMA}, the following parameters should be used to form the input S to the | |
| | KDF: | |
| | - | FC = xxxx(to be allocated by 3GPP) |
| | - | P0 = <SUPI>, |
| | - | L0 = length of <SUPI>. |
| | The input key KEY should be K_{AKMA}. | |
| 6.28.2.3 | Generation of MAC_{EEC} | |
| | When deriving MAC_{EEC} in the UE and AAnF, the following parameters should be used to | |
| | form the input S to the SHA-256 hashing algorithm: | |
| | - | P0 = K_{edge}, |
| | - | P1 = EEC ID, |

The input S should be equal to the concatenation P0||P1 of the P1 and P1.
The MAC_{EEC} is identified with the 32 least significant bits of the output of the SHA-256
function.

6.28.3 Solution Evaluation

This solution requires AAnF to perform the verification of the MAC_{EEC}.
This solution applies to the case when there are multiple EECs in one UE.

Editor's Note: Further evaluation is FFS.

It has been proposed an enhancement of AKMA to enable EES/ECS to authenticate a Generic Public Subscription Identifier (GPSI) present by the EEC. It has been proposed an enhancement of AKMA to enable EES/ECS to handle multiple GPSI case.

One of the requirements on the UE for the AKMA feature in 3GPP TS 33.535 states that “An application on the UE shall not be able to get access to the K_{AF} keys that belong to other application” and the solution #28 in 3GPP TR 33.839 claims that the solution applies to the case when there are multiple EECs in one UE. However, according to the solution (solution #28), every EEC (application on the UE) can fetch the same K_{AKMA} and generate a K_{edge} (K_{AF}) from the K_{AKMA} and the EEC ID (application client ID). Thus, that solution cannot meet the requirement because any EEC in the UE can generate keys of other EECs using the K_{AKMA} and their EEC IDs.

### SUMMARY

Systems and methods for enabling Authentication and Key Management for Applications (AKMA) key diversity for multiple applications are disclosed herein. Embodiments of a method performed by a wireless device for enabling AKMA key diversity for multiple applications are disclosed herein. The method comprises determining, by an AKMA client of the wireless device, a root key (K_{AKMA}) and an AKMA key identifier (A-KID), based on primary authentication with a telecommunications network. The method further comprises receiving, by the AKMA client from an application of the wireless device, an application identifier (APP-ID) and an application function (AF) identifier (AF-ID). The method also comprises verifying, by the AKMA client, the APP-ID, and verifying, by the AKMA client, that the application is entitled to use the AF-ID. The method additionally comprises, responsive to successfully verifying the APP-ID and verifying that the application is entitled to use the AF-ID, deriving an application key (K_{APP}) based on the K_{AKMA}, the AF-ID, and the APP-ID. Optionally, the method further comprises encrypting the APP-ID. Optionally, the method also comprises outputting the A-KID, K_{APP}, and the encrypted APP-ID to the application. The method additionally comprises sending, by the application, a session establishment request to an AF. The session establishment request comprises A-KID and the encrypted APP-ID. Embodiments of a wireless device comprise one or more transmitters, one or more receivers, and processing circuitry configured to cause the wireless device to perform the method described above are also disclosed herein. Embodiments of a wireless device adapted to perform the method described above are also disclosed herein.

Embodiments of a method performed by a wireless device for enabling AKMA key diversity for multiple applications are also disclosed herein. The method comprises determining, by an AKMA client of the wireless device, the K_{AKMA} and the A-KID based on primary authentication with a telecommunications network. The method further comprises receiving, by an AF client of the wireless device from an application of the wireless device, the APP-ID. The method also comprises verifying, by the AF client, the APP-ID. The method additionally comprises receiving, by the AKMA client from the AF client, the AF-ID. The method further comprises verifying, by the AKMA client, that the AF client is entitled to use the AF-ID. The method also comprises, responsive to verifying that the AF client is entitled to use the AF-ID, deriving, by the AKMA client, the K_{AF} based on the K_{AKMA} and the AF-ID. The method additionally comprises receiving, by the AF client from the AKMA client, the A-KID and the K_{AF}. The method further comprises deriving, by the AF client, the K_{APP} based on the K_{AF} and the APP-ID. The method also comprises encrypting, by the AF client, the APP-ID using the K_{AF}. The method additionally comprises outputting the K_{APP}, the A-KID, and the encrypted APP-ID to the application. The method further comprises sending, by the application, a session establishment request to an AF, the session establishment request comprising the A-KID and the encrypted APP-ID. Embodiments of a wireless device comprising one or more transmitters, one or more receivers, and processing circuitry configured to cause the wireless device to perform the method described above are also disclosed herein. Embodiments of a wireless device adapted to perform the method described above are also disclosed herein.

Embodiments of a method performed by a network node implementing an AF for enabling AKMA key diversity for multiple wireless device applications are also disclosed herein. The method comprises receiving, from an application of a wireless device, a session establishment request comprising an A-KID and a cleartext or encrypted APP-ID. The method further comprises obtaining an K_{APP} based on the APP-ID, which is a cleartext or encrypted. Optionally, the method further comprises obtaining an K_{APP} based on the K_{AKMA}, the AF-ID and the APP-ID. The method also comprises executing an authentication protocol for the application using the K_{APP}. Embodiments of a network node comprising one or more transmitters, one or more receivers, and processing circuitry configured to cause the network node to perform the method described above are also disclosed herein. Embodiments of a network node adapted to perform the method described above are also disclosed herein.

Embodiments of a method performed by a network node implementing an AF for enabling AKMA key diversity for multiple wireless device applications are also disclosed herein. The method comprises receiving, from an application of a wireless device, a session establishment request comprising an A-KID and an encrypted APP-ID, encrypted using an K_{AKMA}. The method further comprises sending, to the telecommunications network, a request for an K_{AF}, the request comprising the A-KID and the encrypted APP-ID. The method also comprises obtaining, from the telecommunications network, the K_{AF} or a K_{APP} and the decrypted APP-ID. The method additionally comprises obtaining an K_{APP} based the K_{AKMA}, the AF-ID, and the decrypted APP-ID. The method further comprises executing an authentication protocol for the application using the K_{APP}. Embodiments of a network node comprising one or more transmitters, one or more receivers, and processing circuitry configured to cause the network node to perform the method described above are also disclosed herein. Embodiments of a network node adapted to perform the method described above are also disclosed herein. For example, another embodiments for the AF side can be added to cover the case that the APP-ID is encrypted using the K_{AF}.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an exemplary edge computing architecture according to Third Generation Partnership Project (3GPP) Technical Specification (TS) 23.558;

FIG. 2, which reproduces FIG. 6.28.2.1-1 of 3GPP Technical Report (TR) 33.839, illustrates exemplary communication flows when performing authentication between an Edge Enabler Client (EEC) and an Edge Configuration Server (ECS) based on Authentication and Key Management for Applications (AKMA);

FIG. 3 illustrates one example of a cellular communications system according to some embodiments of the present disclosure;

FIGS. 4 and 5 illustrate example embodiments in which the cellular communication system of FIG. 3 is a Fifth Generation System (5GS);

FIGS. 6 and 7 illustrate architectures associated with a first embodiment and a second embodiment, respectively;

FIG. 8 illustrates exemplary communication flows according to the first embodiment disclosed herein;

FIG. 9 illustrates exemplary communication flows according to the second embodiment disclosed herein;

FIG. 10 is a schematic block diagram of a radio access node according to some embodiments of the present disclosure;

FIG. 11 is a schematic block diagram that illustrates a virtualized embodiment of the radio access node of FIG. 10 according to some embodiments of the present disclosure;

FIG. 12 is a schematic block diagram of the radio access node of FIG. 10 according to some other embodiments of the present disclosure;

FIG. 13 is a schematic block diagram of a User Equipment (UE) according to some embodiments of the present disclosure;

FIG. 14 is a schematic block diagram of the UE of FIG. 13 according to some other embodiments of the present disclosure;

FIG. 15 illustrates a telecommunication network connected via an intermediate network to a host computer in accordance with some embodiments of the present disclosure;

FIG. 16 is a generalized block diagram of a host computer communicating via a base station with a UE over a partially wireless connection in accordance with some embodiments of the present disclosure;

FIG. 17 is a flowchart illustrating a method implemented in a communication system in accordance with one embodiment of the present disclosure;

FIG. 18 is a flowchart illustrating a method implemented in a communication system in accordance with one embodiment of the present disclosure;

FIG. 19 is a flowchart illustrating a method implemented in a communication system in accordance with one embodiment of the present disclosure; and

FIG. 20 is a flowchart illustrating a method implemented in a communication system in accordance with one embodiment of the present disclosure.

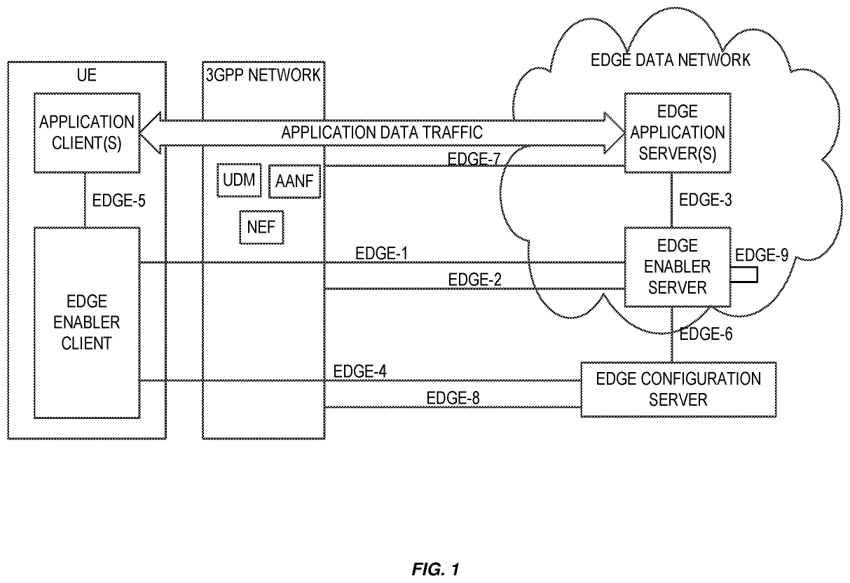

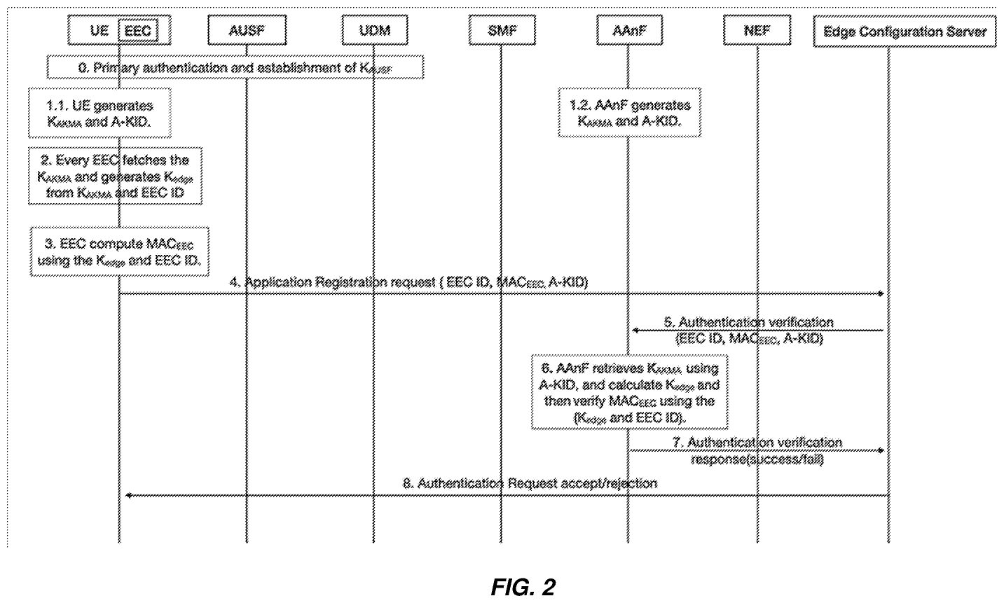

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.
Radio Node: As used herein, a “radio node” is either a radio access node or a wireless communication device.
Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.
Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.
Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.
Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.
Network Node: As used herein, a “network node” is any node that is either part of the RAN or the core network of a cellular communications network/system.
Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Systems and methods for enabling Authentication and Key Management for Applications (AKMA) key diversity for multiple applications are disclosed herein. In particular, embodiments are proposed for using an AKMA key (K_{AKMA}), an Application Function (AF) identifier (AF_ID), and an application ID (APP_ID) in the derivation of application key K_{APP}.

In one embodiment, a new functionality, referred to herein as an ‘AKMA Client,’ is introduced in a User Equipment (UE). The AKMA Client authenticates and authorizes an Application on the UE before giving the K_{APP} to the Application. There may be multiple options for the key derivation (note that KDF represents a key derivation function), such as the two options below:
Key derivation option #1) K_{AF}=KDF (K_{AKMA}, AF-ID)
   K_{APP}=KDF (K_{AF}, APP-ID)
Key derivation option #2) K_{APP}=KDF (K_{AKMA}, AF-ID, APP-ID)

Option #1 above may be useful to hide the APP-ID in the first message from the Application on the UE to the AF by using the K_{AF} key.

Another embodiment employs the AKMA Client functionality, and additionally provides an AF Client, which runs in the UE. The AKMA Client authenticates and authorizes the AF Client before giving the K_{AF} key to the AF Client. The AF Client authenticates and authorizes the Application on the UE before giving the K_{APP} key to the Application. In this embodiment, the key derivation is executed as follows (e.g., in a manner similar to the key derivation option #1 of the first embodiment discussed above):
K_{AF}=KDF (K_{AKMA}, AF-ID)
K_{APP}=KDF (K_{AF}, APP-ID)

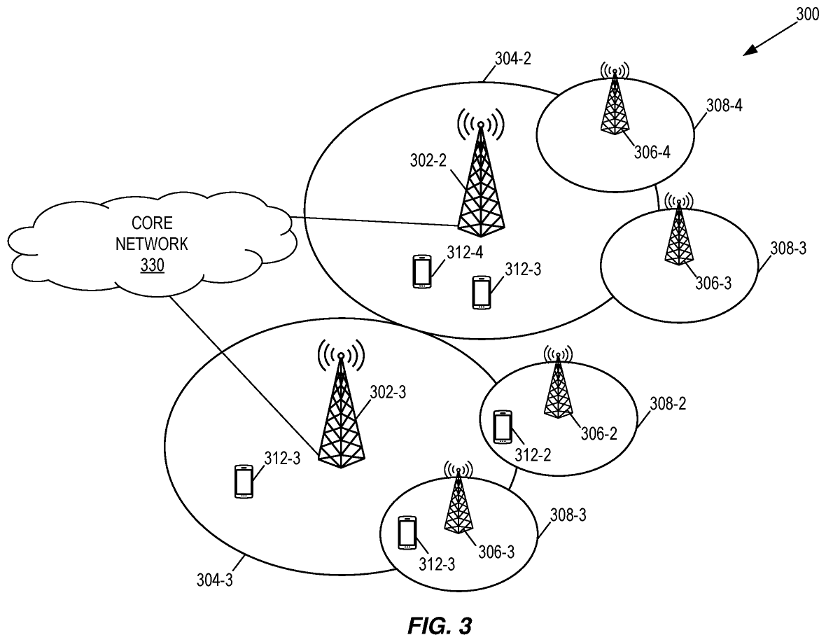

Before describing operations for enabling AKMA key diversity for multiple applications, embodiments of cellular communication systems in which embodiments of the present disclosure may be implemented are first discussed. In this regard, FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 302-1 and 302-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or RRHs, or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5G System (5GS) is referred to as the 5GC. The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs, but the present disclosure is not limited thereto.

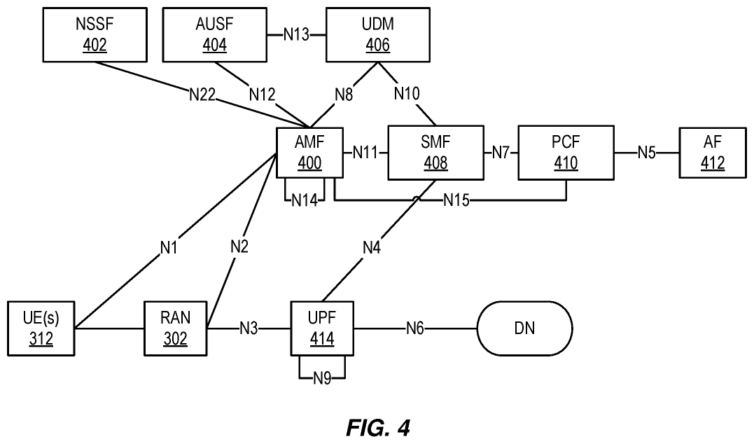

FIG. 4 illustrates a wireless communication system represented as a 5G network architecture composed of core Network Functions (NFs), where interaction between any two NFS is represented by a point-to-point reference point/interface. FIG. 4 can be viewed as one particular implementation of the system 300 of FIG. 3.

Seen from the access side the 5G network architecture shown in FIG. 4 comprises a plurality of UEs 312 connected to either a RAN 302 or an Access Network (AN) as well as an AMF 400. Typically, the RAN 302 comprises base stations, e.g., such as eNBs or gNBs or similar. Seen from the core network side, the 5GC NFs shown in FIG. 4 include a NSSF 402, an AUSF 404, a UDM 406, the AMF 400, a SMF 408, a PCF 410, and an Application Function (AF) 412.

Reference point representations of the 5G network architecture are used to develop detailed call flows in the normative standardization. The N1 reference point is defined to carry signaling between the UE 312 and AMF 400. The reference points for connecting between the AN 302 and AMF 400 and between the AN 302 and UPF 414 are defined as N2 and N3, respectively. There is a reference point, N11, between the AMF 400 and SMF 408, which implies that the SMF 408 is at least partly controlled by the AMF 400. N4 is used by the SMF 408 and UPF 414 so that the UPF 414 can be set using the control signal generated by the SMF 408, and the UPF 414 can report its state to the SMF 408. N9 is the reference point for the connection between different UPFs 414, and N14 is the reference point connecting between different AMFs 400, respectively. N15 and N7 are defined since the PCF 410 applies policy to the AMF 400 and SMF 408, respectively. N12 is required for the AMF 400 to perform authentication of the UE 312. N8 and N10 are defined because the subscription data of the UE 312 is required for the AMF 400 and SMF 408.

The 5GC network aims at separating User Plane (UP) and Control Plane (CP). The UP carries user traffic while the CP carries signaling in the network. In FIG. 4, the UPF 414 is in the UP and all other NFs, i.e., the AMF 400, SMF 408, PCF 410, AF 412, NSSF 402, AUSF 404, and UDM 406, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 400 and SMF 408 are independent functions in the CP. Separated AMF 400 and SMF 408 allow independent evolution and scaling. Other CP functions like the PCF 410 and AUSF 404 can be separated as shown in FIG. 4. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

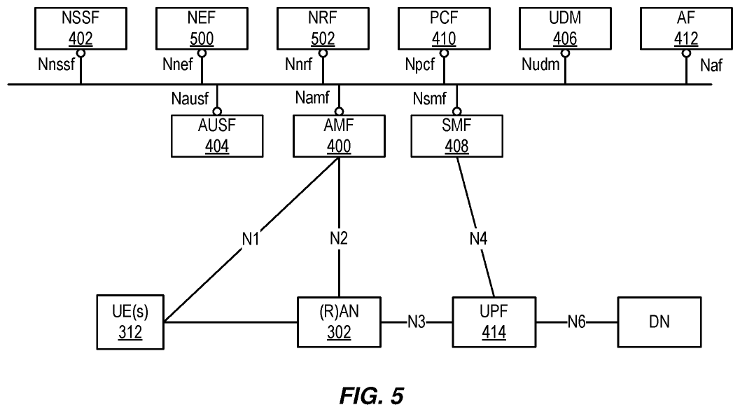

FIG. 5 illustrates a 5G network architecture using service-based interfaces between the NFs in the CP, instead of the point-to-point reference points/interfaces used in the 5G network architecture of FIG. 4. However, the NFs described above with reference to FIG. 4 correspond to the NFs shown in FIG. 5. The service(s) etc. that a NF provides to other authorized NFs can be exposed to the authorized NFs through the service-based interface. In FIG. 5 the service based interfaces are indicated by the letter “N” followed by the name of the NF, e.g. Namf for the service based interface of the AMF 400 and Nsmf for the service based interface of the SMF 408, etc. The NEF 500 and the NRF 502 in FIG. 5 are not shown in FIG. 4 discussed above. However, it should be clarified that all NFs depicted in FIG. 4 can interact with the NEF 500 and the NRF 502 of FIG. 5 as necessary, though not explicitly indicated in FIG. 4.

Some properties of the NFs shown in FIGS. 4 and 5 may be described in the following manner. The AMF 400 provides UE-based authentication, authorization, mobility management, etc. A UE 312 even using multiple access technologies is basically connected to a single AMF 400 because the AMF 400 is independent of the access technologies. The SMF 408 is responsible for session management and allocates Internet Protocol (IP) addresses to UEs. It also selects and controls the UPF 414 for data transfer. If a UE 312 has multiple sessions, different SMFs 408 may be allocated to each session to manage them individually and possibly provide different functionalities per session. The AF 412 provides information on the packet flow to the PCF 410 responsible for policy control in order to support QoS. Based on the information, the PCF 410 determines policies about mobility and session management to make the AMF 400 and SMF 408 operate properly. The AUSF 404 supports authentication function for UEs or similar and thus stores data for authentication of UEs or similar while the UDM 406 stores subscription data of the UE 312. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

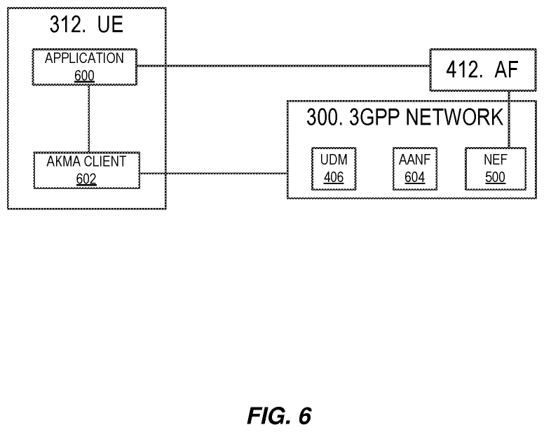

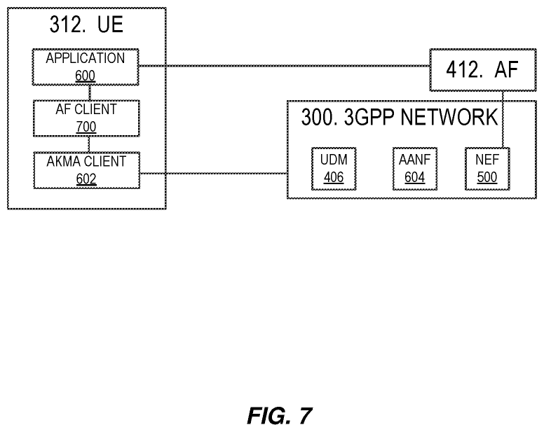

Embodiments disclosed herein enable AKMA key diversity for multiple applications. FIGS. 6 and 7 illustrate architectures associated with the first embodiment and the second embodiment, respectively, discussed above. In FIGS. 6 and 7, note that the AF 412 can be internal or external to the 3GPP system. In FIG. 6, for the Edge Computing case, the Application 600 on the UE 312 is the EEC, and the AF 412 is the ECS or EES. In FIG. 7, for the Edge Computing case, the Application 600 on the UE 312 is the EEC and the AF 412 is the ECS or EES, and the AF client 700 could be an ECS client or an EES client accordingly.

FIG. 8 illustrates exemplary communication flows according to a first embodiment disclosed herein. Operations in FIG. 8 are performed as follows:
Operation 800 of FIG. 8, a UE 312 and a 3GPP network 300 run primary authentication and derive a K_{AKMA}. An AKMA Client 602 learns an AKMA Key Identifier (A-KID) and the K_{AKMA}.
Operation 801: For the K_{APP} request, the Application 600 inputs an Application Identifier (APP-ID) and an Application Function Identifier (AF-ID) to the AKMA Client 602.
Operation 802: The AKMA Client 602 executes an authentication and authorization protocol and verifies the APP-ID, and verifies that the Application 600 is entitled to use the AF-ID. If the result is successful, the AKMA client 602 performs the following operations where a Key Derivation Function (KDF) is a key derivation function, and E is an encryption algorithm such that E(X, Y) is the encryption of Y under the key X:
K_{AF}=KDF(K_{AKMA}, AF-ID)
K_{APP}=KDF(K_{AF}, APP-ID)
E(K_{AF}, APP-ID)
Operation 803: The AKMA Client 602 outputs the A-KID, the K_{APP} and E(K_{AF}, APP-ID) to the Application 600.
Operation 804: The Application sends a session establishment request to the AF, including the parameters, the A-KID and E(K_{AF}, APP-ID).
Operation 805: The AF 412 requests the K_{AF} from the 3GPP network 300. In this request, the AF 412 sends the A-KID and the AF-ID.
Operation 806: The 3GPP network 300 executes authentication and authorization for the AF 412, and if successful, derives the K_{AF} such that K_{AF}=KDF(K_{AKMA}, AF-ID).
Operation 807: The 3GPP network 300 sends the K_{AF} and expire time for the key to the AF 412.
Operation 808: Using the K_{AF} key, the AF 412 decrypts the encrypted APP-ID and also derives a K_{APP} such that K_{APP}=KDF(K_{AF}, APP-ID).
Operation 809: The Application 600 and the AF 412 execute an authentication protocol using the K_{APP} key to ensure that they hold the same key.

In some embodiments, for the encryption of the APP-ID in Operation 802, the K_{AKMA} can be used instead of the K_{AF}. In this case, the AF 412 sends the encrypted APP-ID to the 3GPP network 300 in operation 805, the network performs the decryption using the K_{AKMA} in operation 6 and returns the APP-ID to the AF 412 in operation 807. Thus, there will be no need to decrypt the APP-ID in operation 808.

Some embodiments may operate as described above, but with the following differences:
the K_{APP} key is derived as K_{APP}=KDF(K_{AKMA}, AF-ID, APP-ID) in operation 802 of FIG. 8.
In operation 803, the AKMA Client 602 outputs an A-KID and the K_{APP} to the Application 600.
In operation 804, the Application 600 sends the A-KID and the APP-ID to the AF 412.
In operation 805, the AF 412 also sends the APP-ID to the 3GPP network 300.
In operation 806, the 3GPP network 300 computes the K_{APP} instead of K_{AF} as follows:
   K_{APP}=KDF(K_{AKMA}, AF-ID, APP-ID).
In operation 807, the 3GPP network 300 sends the K_{APP} instead of K_{AF} to the AF 412.
In operation 808, there is no APP-ID decryption and no K_{APP} derivation because the APP-ID has been received in plaintext in operation 804 and the K_{APP} has been received in operation 807.

To send the APP-ID as encrypted in operation 804, the following additional operations are done:
In operation 802, the AKMA client 602 also computes E(K_{AKMA}, APP-ID).
In operation 803, the AKMA client 602 also outputs E(K_{AKMA}, APP-ID) to the Application 600.
In operation 804, the Application 600 sends E(K_{AKMA}, APP-ID) instead of the APP-ID to the AF 412.
In operation 805, the AF 412 sends E(K_{AKMA}, APP-ID) instead of the APP-ID to the 3GPP network 300.
In operation 806, the 3GPP network 300 also decrypts the encrypted APP-ID.
In operation 807, the 3GPP network 300 sends also the APP-ID to the AF 412.

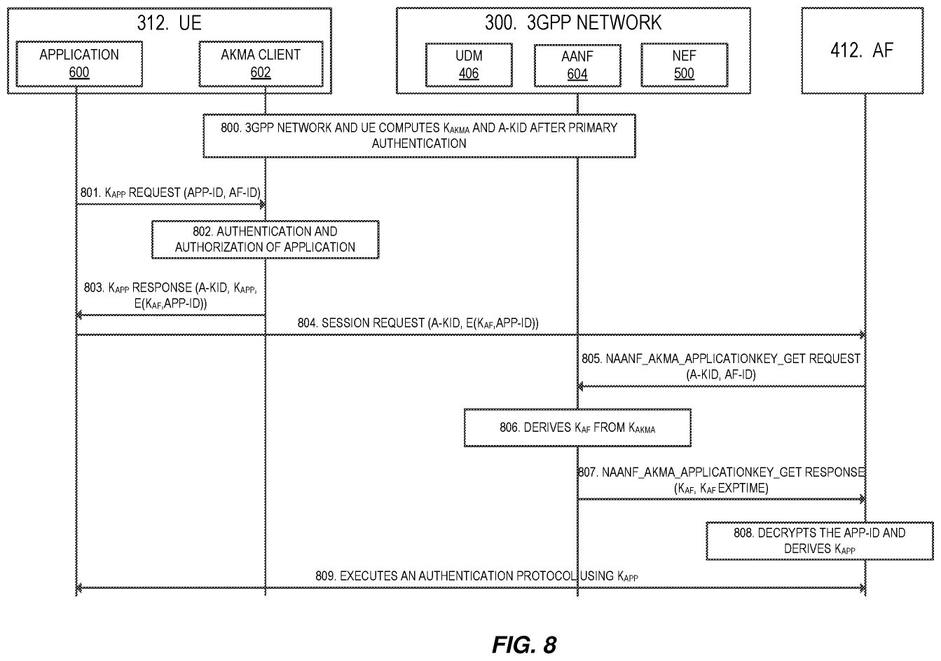

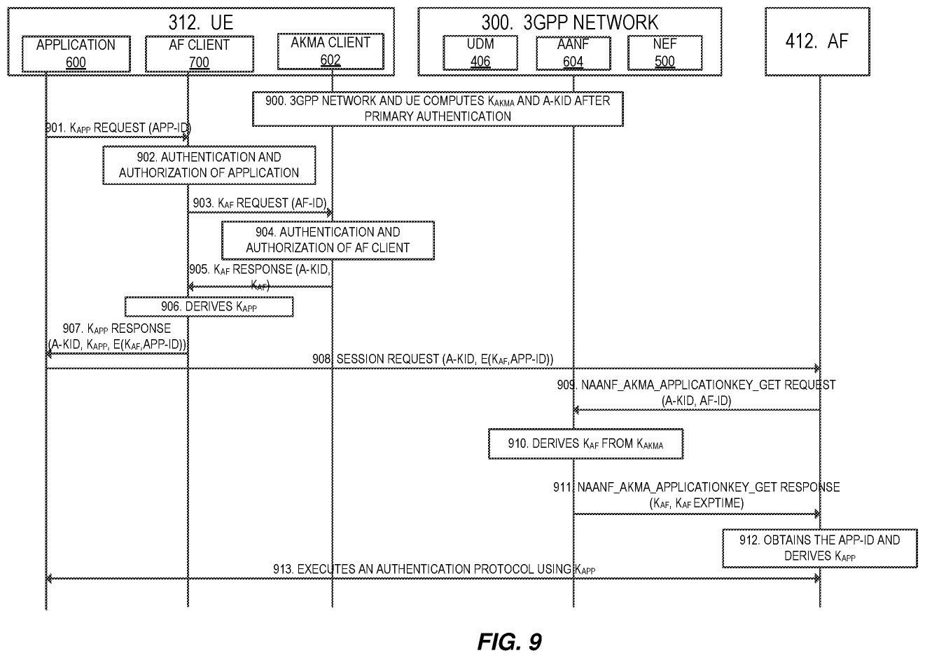

FIG. 9 illustrates exemplary communication flows according to a second embodiment disclosed herein. Operations in FIG. 9 are performed as follows:
Operation 900: The UE 312 and the 3GPP network 300 run primary authentication and derive a K_{AKMA}. The AKMA Client 602 learns the A-KID and the K_{AKMA}.
Operation 901: For the K_{APP} request, the Application 600 inputs an APP-ID to the AF Client 700. The Application 600 selects the AF client 700 based on the AF-ID.
Operation 902: The AF Client 700 executes an authentication and authorization protocol and verify the APP-ID and if the result is successful then the next operations are performed.
Operation 903: For the K_{AF} request, the AF Client 700 inputs the AF-ID to the AKMA Client 602.
Operation 904: The AKMA Client 602 executes an authentication and authorization protocol and verify the AF Client 700 is entitled to use the AF-ID and if the result is successful then performs the following operation:
K_{AF}=KDF(K_{AKMA}, AF-ID)
Operation 905: The AKMA Client 602 sends the A-KID and the K_{AF} to the AF Client 700.
Operation 906: The AF Client 700 performs the following computations:
K_{APP}=KDF(K_{AF}, APP-ID)
E(K_{AF}, APP-ID)
Operation 907: The AF client 700 outputs the K_{APP} and E(K_{AF}, APP-ID) to the Application 600. The AF client 700 also outputs the A-KID to the Application 600.
Operation 908: The Application 600 sends a session establishment request to the AF 412, including the parameters, the A-KID and E(K_{AF}, APP-ID).
Operations 909-913 of FIG. 9 correspond to operations 805-809 of FIG. 8, the description of which will not be repeated here for the sake of brevity.

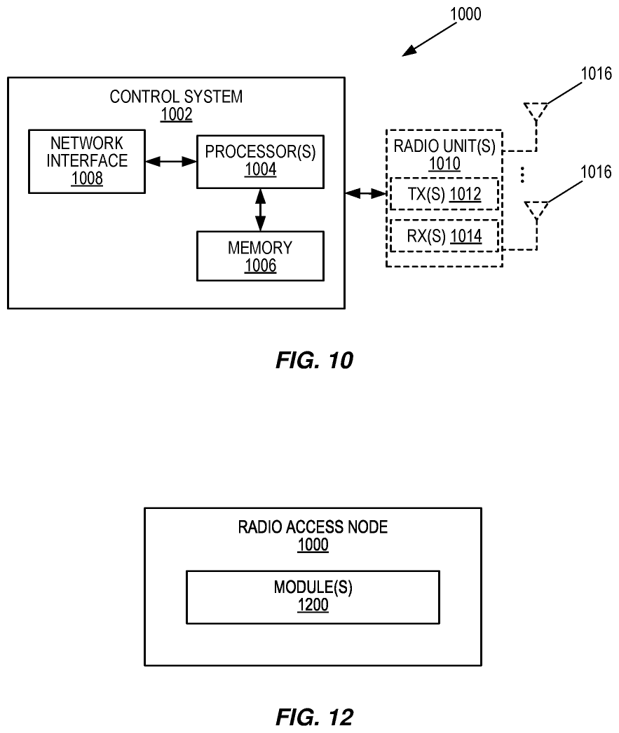

FIG. 10 is a schematic block diagram of a radio access node 1000 according to some embodiments of the present disclosure. Optional features are represented by dashed boxes. The radio access node 1000 may be, for example, a base station 302 or 306 or a network node that implements all or part of the functionality of the base station 302 or gNB described herein. As illustrated, the radio access node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, the radio access node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of a radio access node 1000 as described herein. In some embodiments, the function(s) are implemented in software that is stored, e.g., in the memory 1006 and executed by the one or more processors 1004.

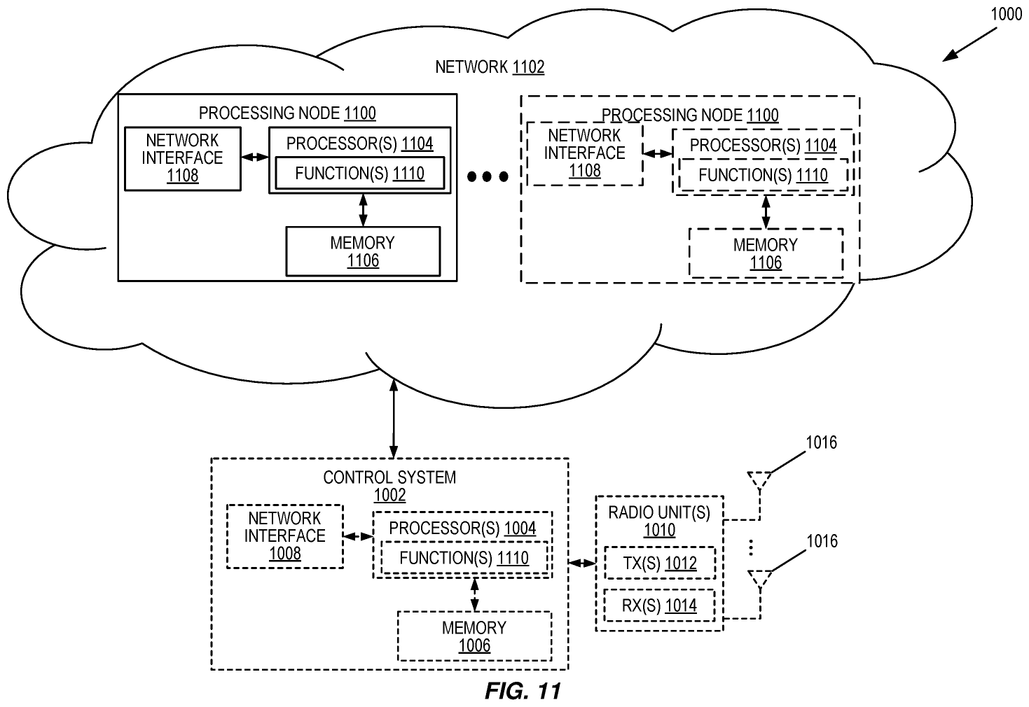

FIG. 11 is a schematic block diagram that illustrates a virtualized embodiment of the radio access node 1000 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1000 in which at least a portion of the functionality of the radio access node 1000 is implemented as a virtual component(s) (e.g., via a virtual machine(s) executing on a physical processing node(s) in a network(s)). As illustrated, in this example, the radio access node 1000 may include the control system 1002 and/or the one or more radio units 1010, as described above. The control system 1002 may be connected to the radio unit(s) 1010 via, for example, an optical cable or the like. The radio access node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the radio access node 1000 described herein are implemented at the one or more processing nodes 1100 or distributed across the one or more processing nodes 1100 and the control system 1002 and/or the radio unit(s) 1010 in any desired manner. In some particular embodiments, some or all of the functions 1110 of the radio access node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of radio access node 1000 or a node (e.g., a processing node 1100) implementing one or more of the functions 1110 of the radio access node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the radio access node 1000 according to some other embodiments of the present disclosure. The radio access node 1000 includes one or more modules 1200, each of which is implemented in software. The module(s) 1200 provide the functionality of the radio access node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

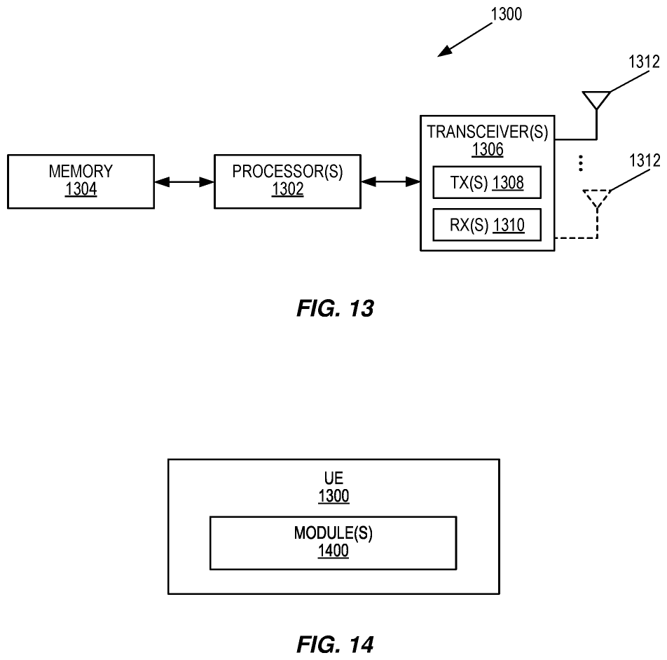

FIG. 13 is a schematic block diagram of a wireless communication device 1300 according to some embodiments of the present disclosure. As illustrated, the wireless communication device 1300 includes one or more processors 1302 (e.g., CPUs, ASICs, FPGAS, and/or the like), memory 1304, and one or more transceivers 1306 each including one or more transmitters 1308 and one or more receivers 1310 coupled to one or more antennas 1312. The transceiver(s) 1306 includes radio-front end circuitry connected to the antenna(s) 1312 that is configured to condition signals communicated between the antenna(s) 1312 and the processor(s) 1302, as will be appreciated by on of ordinary skill in the art. The processors 1302 are also referred to herein as processing circuitry. The transceivers 1306 are also referred to herein as radio circuitry. In some embodiments, the functionality of the wireless communication device 1300 described above may be fully or partially implemented in software that is, e.g., stored in the memory 1304 and executed by the processor(s) 1302. Note that the wireless communication device 1300 may include additional components not illustrated in FIG. 13 such as, e.g., one or more user interface components (e.g., an input/output interface including a display, buttons, a touch screen, a microphone, a speaker(s), and/or the like and/or any other components for allowing input of information into the wireless communication device 1300 and/or allowing output of information from the wireless communication device 1300), a power supply (e.g., a battery and associated power circuitry), etc.

In some embodiments, a computer program including instructions which, when executed by at least one processor, causes the at least one processor to carry out the functionality of the wireless communication device 1300 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 14 is a schematic block diagram of the wireless communication device 1300 according to some other embodiments of the present disclosure. The wireless communication device 1300 includes one or more modules 1400, each of which is implemented in software. The module(s) 1400 provide the functionality of the wireless communication device 1300 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

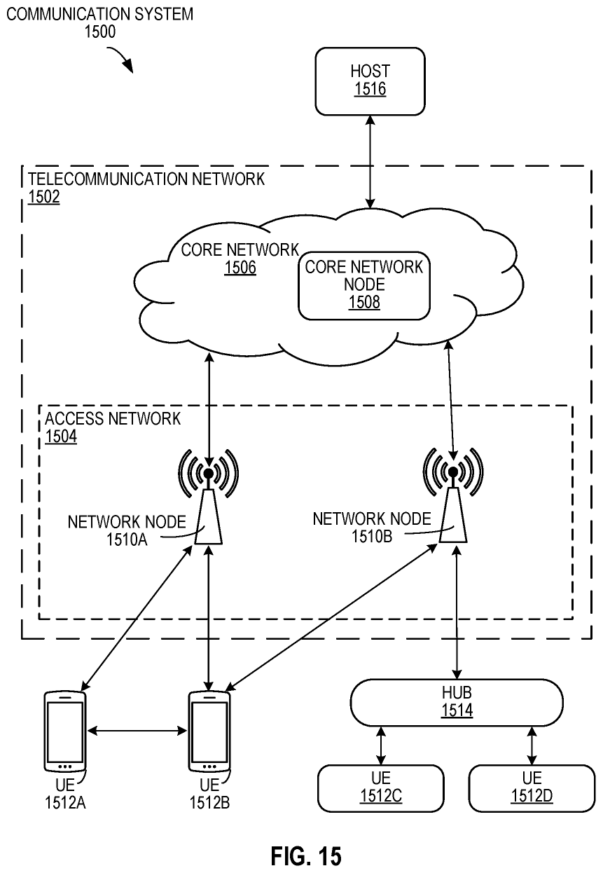

FIG. 15 shows an example of a communication system 1500 in accordance with some embodiments.

In the example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510a and 1510b (one or more of which may be generally referred to as network nodes 1510), or any other similar 3rd Generation Partnership Project (3GPP) access node or non-3GPP access point. The network nodes 1510 facilitate direct or indirect connection of user equipment (UE), such as by connecting UEs 1512a, 1512b, 1512c, and 1512d (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular in if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510b. In other embodiments, the hub 1514 may be a non-dedicated hub—that is, a device which is capable of operating to route communications between the UEs and network node 1510b, but which is additionally capable of operating as a communication start and/or end point for certain data channels.

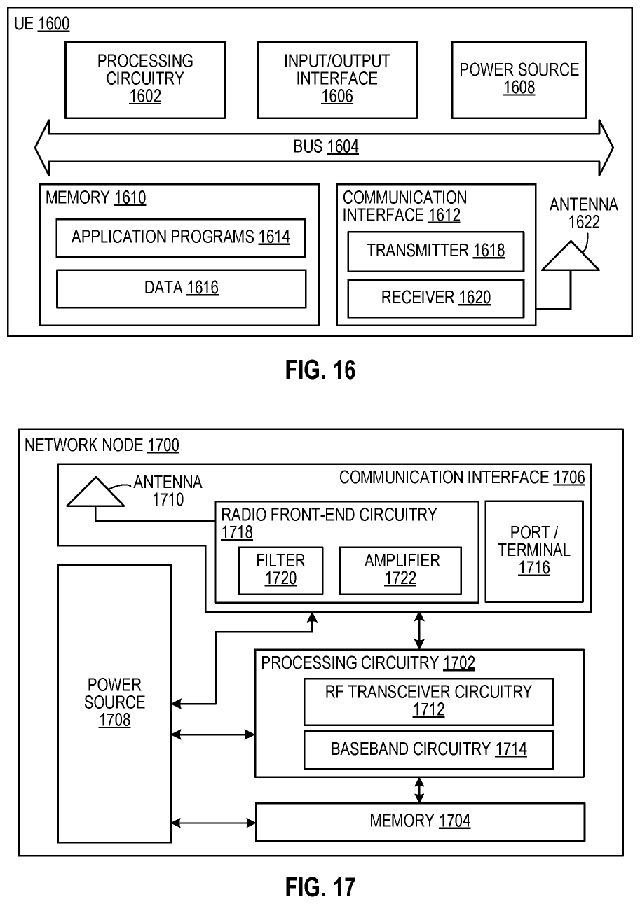

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs).

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software, or firmware, or alternatively be implemented separately.

In the illustrated embodiment, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user-initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes a processing circuitry 1702, a memory 1704, a communication interface 1706, and a power source 1708. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, to provide network node 1700 functionality.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part, or all of RF transceiver circuitry 1712 and baseband processing circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all, or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

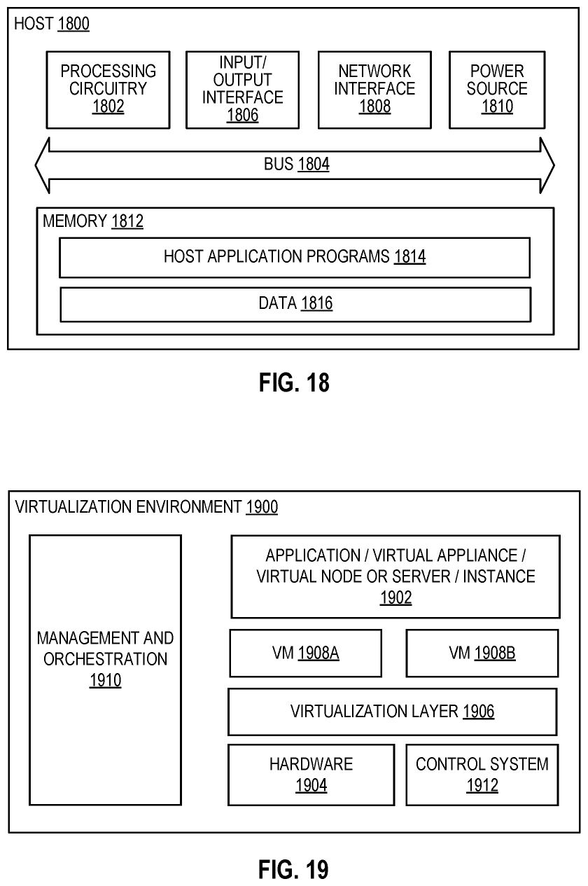

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1902 (which may alternatively be called software instances, virtual appliances, network functions, virtual nodes, virtual network functions, etc.) are run in the virtualization environment 1900 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g., such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

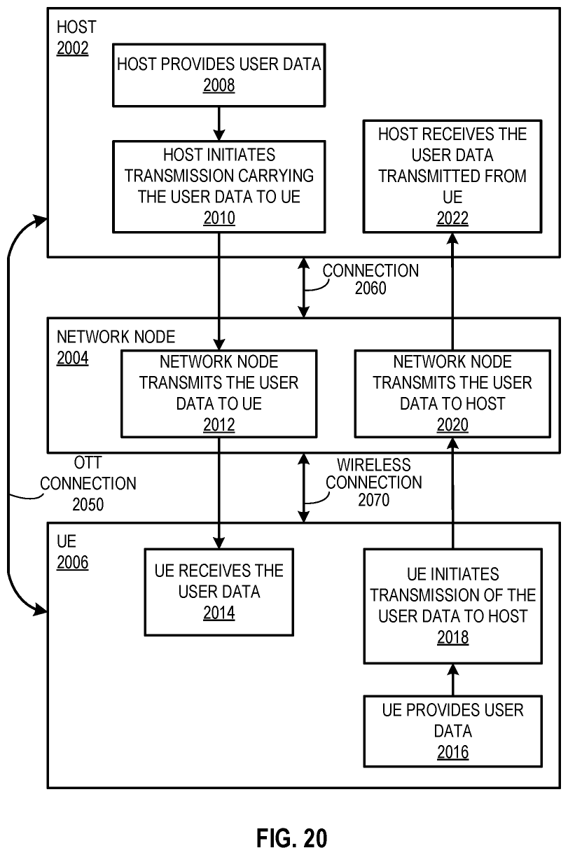

FIG. 20 shows a communication diagram of a host 2002 communicating via a network node 2004 with a UE 2006 over a partially wireless connection in accordance with some embodiments. Example implementations, in accordance with various embodiments, of the UE (such as a UE 1512a of FIG. 15 and/or UE 1600 of FIG. 16), network node (such as network node 1510a of FIG. 15 and/or network node 1700 of FIG. 17), and host (such as host 1516 of FIG. 15 and/or host 1800 of FIG. 18) discussed in the preceding paragraphs will now be described with reference to FIG. 20.

Like host 1800, embodiments of host 2002 include hardware, such as a communication interface, processing circuitry, and memory. The host 2002 also includes software, which is stored in or accessible by the host 2002 and executable by the processing circuitry. The software includes a host application that may be operable to provide a service to a remote user, such as the UE 2006 connecting via an over-the-top (OTT) connection 2050 extending between the UE 2006 and host 2002. In providing the service to the remote user, a host application may provide user data which is transmitted using the OTT connection 2050.

The network node 2004 includes hardware enabling it to communicate with the host 2002 and UE 2006. The connection 2060 may be direct or pass through a core network (like core network 1506 of FIG. 15) and/or one or more other intermediate networks, such as one or more public, private, or hosted networks. For example, an intermediate network may be a backbone network or the Internet.

The UE 2006 includes hardware and software, which is stored in or accessible by UE 2006 and executable by the UE's processing circuitry. The software includes a client application, such as a web browser or operator-specific “app” that may be operable to provide a service to a human or non-human user via UE 2006 with the support of the host 2002. In the host 2002, an executing host application may communicate with the executing client application via the OTT connection 2050 terminating at the UE 2006 and host 2002. In providing the service to the user, the UE's client application may receive request data from the host's host application and provide user data in response to the request data. The OTT connection 2050 may transfer both the request data and the user data. The UE's client application may interact with the user to generate the user data that it provides to the host application through the OTT connection 2050.

The OTT connection 2050 may extend via a connection 2060 between the host 2002 and the network node 2004 and via a wireless connection 2070 between the network node 2004 and the UE 2006 to provide the connection between the host 2002 and the UE 2006. The connection 2060 and wireless connection 2070, over which the OTT connection 2050 may be provided, have been drawn abstractly to illustrate the communication between the host 2002 and the UE 2006 via the network node 2004, without explicit reference to any intermediary devices and the precise routing of messages via these devices.

As an example of transmitting data via the OTT connection 2050, in step 2008, the host 2002 provides user data, which may be performed by executing a host application. In some embodiments, the user data is associated with a particular human user interacting with the UE 2006. In other embodiments, the user data is associated with a UE 2006 that shares data with the host 2002 without explicit human interaction. In step 2010, the host 2002 initiates a transmission carrying the user data towards the UE 2006. The host 2002 may initiate the transmission responsive to a request transmitted by the UE 2006. The request may be caused by human interaction with the UE 2006 or by operation of the client application executing on the UE 2006. The transmission may pass via the network node 2004, in accordance with the teachings of the embodiments described throughout this disclosure. Accordingly, in step 2012, the network node 2004 transmits to the UE 2006 the user data that was carried in the transmission that the host 2002 initiated, in accordance with the teachings of the embodiments described throughout this disclosure. In step 2014, the UE 2006 receives the user data carried in the transmission, which may be performed by a client application executed on the UE 2006 associated with the host application executed by the host 2002.

In some examples, the UE 2006 executes a client application which provides user data to the host 2002. The user data may be provided in reaction or response to the data received from the host 2002. Accordingly, in step 2016, the UE 2006 may provide user data, which may be performed by executing the client application. In providing the user data, the client application may further consider user input received from the user via an input/output interface of the UE 2006. Regardless of the specific manner in which the user data was provided, the UE 2006 initiates, in step 2018, transmission of the user data towards the host 2002 via the network node 2004. In step 2020, in accordance with the teachings of the embodiments described throughout this disclosure, the network node 2004 receives user data from the UE 2006 and initiates transmission of the received user data towards the host 2002. In step 2022, the host 2002 receives the user data carried in the transmission initiated by the UE 2006.

One or more of the various embodiments improve the performance of OTT services provided to the UE 2006 using the OTT connection 2050, in which the wireless connection 2070 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host 2002. As another example, the host 2002 may process audio and video data which may have been retrieved from a UE for use in creating maps. As another example, the host 2002 may collect and analyze real-time data to assist in controlling vehicle congestion (e.g., controlling traffic lights). As another example, the host 2002 may store surveillance video uploaded by a UE. As another example, the host 2002 may store or control access to media content such as video, audio, VR or AR which it can broadcast, multicast or unicast to UEs. As other examples, the host 2002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection 2050 between the host 2002 and UE 2006, in response to variations in the measurement results. The measurement procedure and/or the network functionality for reconfiguring the OTT connection may be implemented in software and hardware of the host 2002 and/or UE 2006. In some embodiments, sensors (not shown) may be deployed in or in association with other devices through which the OTT connection 2050 passes; the sensors may participate in the measurement procedure by supplying values of the monitored quantities exemplified above, or supplying values of other physical quantities from which software may compute or estimate the monitored quantities. The reconfiguring of the OTT connection 2050 may include message format, retransmission settings, preferred routing etc.; the reconfiguring need not directly alter the operation of the network node 2004. Such procedures and functionalities may be known and practiced in the art. In certain embodiments, measurements may involve proprietary UE signaling that facilitates measurements of throughput, propagation times, latency, and the like, by the host 2002. The measurements may be implemented in that software causes messages to be transmitted, in particular empty or ‘dummy’ messages, using the OTT connection 2050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless device for enabling Authentication and Key Management for Applications, AKMA, key diversity for multiple applications, the method comprising:
determining, by an AKMA client of the wireless device, a root key, K_{AKMA}, and an AKMA key identifier, A-KID, based on primary authentication with a telecommunications network 300;
receiving, by the AKMA client from an application of the wireless device, an application identifier, APP-ID, and an Application Function, AF, identifier, AF-ID;
verifying, by the AKMA client, the APP-ID;
verifying, by the AKMA client, that the application is entitled to use the AF-ID; and
responsive to successfully verifying the APP-ID and verifying that the application is entitled to use the AF-ID:
deriving an application key, K_{APP}, based on the K_{AKMA}, the AF-ID, and the APP-ID.

2. The method of claim 1, responsive to successfully verifying the APP-ID and verifying that the application is entitled to use the AF-ID, further comprising:
encrypting the APP-ID;
outputting the A-KID, the K_{APP}, and the encrypted APP-ID to the application; and
sending, by the application, a session establishment request to an AF, the session establishment request comprising the A-KID and the encrypted APP-ID.

3. The method of claim 2, wherein:
deriving K_{APP} based on the K_{AKMA}, the AF-ID, and the APP-ID comprises:
deriving, using a key derivation function, KDF, an AF key, K_{AF}, based on the K_{AKMA} and the AF-ID; and
deriving, using the KDF, the K_{APP} based on the K_{AF} and the APP-ID; and
encrypting the APP-ID comprises encrypting APP-ID using one of the K_{AKMA} and the K_{AF}.

4. The method of claim 2, wherein:
deriving the K_{APP} based on the K_{AKMA}, the AF-ID, and the APP-ID comprises deriving, using a key derivation function, KDF, the K_{APP} based on the K_{AKMA}, the AF-ID, and the APP-ID; and
encrypting APP-ID comprises encrypting APP-ID using the K_{AKMA}.

5-8. (canceled)

9. A method performed by a wireless device for enabling Authentication and Key Management for Applications, AKMA, key diversity for multiple applications, the method comprising:
determining, by an AKMA client of the wireless device, a root key, K_{AKMA}, and an AKMA key identifier, A-KID, based on primary authentication with a telecommunications network;
receiving, by an Application Function, AF, client of the wireless device from an application of the wireless device, an application identifier, APP-ID;
verifying, by the AF client, APP-ID;
receiving, by the AKMA client from the AF client, an application function, AF, identifier, AF-ID;
verifying, by the AKMA client, that the AF client is entitled to use the AF-ID;
responsive to verifying that the AF client is entitled to use AF-ID, deriving, by the AKMA client, an AF key, K_{AF}, based on the K_{AKMA} and the AF-ID;
receiving, by the AF client from the AKMA client, the A-KID and the K_{AF};
deriving, by the AF client, an application key, K_{APP}, based on the K_{AF} and the APP-ID;
encrypting, by the AF client, APP-ID using the K_{AF};
outputting K_{APP}, A-KID, and the encrypted APP-ID to the application; and
sending, by the application, a session establishment request to an AF 412, the session establishment request comprising the A-KID and the encrypted APP-ID.

10-11. (canceled)

12. A method performed by a network node implementing an Application Function, AF, for enabling Authentication and Key Management for Applications, AKMA, key diversity for multiple wireless device applications, the method comprising:
receiving, from an application of a wireless device, a session establishment request comprising an AKMA key identifier, A-KID, and an application identifier, APP-ID;
obtaining an application key, K_{APP}, based on the APP-ID; and
executing an authentication protocol for the application using K_{APP}.

13. The method of claim 12, wherein:
the APP-ID comprises an encrypted APP-ID encrypted using an AF key, K_{AF}; and
the method further comprises:
sending, to the telecommunications network, a request for an AF key, K_{AF};
obtaining, from the telecommunications network, K_{AF}; and
decrypting the encrypted APP-ID using the K_{AF} as a decrypted APP-ID.

14. The method of claim 12, wherein:
the APP-ID comprises an encrypted APP-ID encrypted using an AKMA key, K_{AKMA}; and
the method further comprises:
sending the encrypted APP-ID to the telecommunications network; and
receiving a decrypted APP-ID from the telecommunications network.

15. The method of claim 13, wherein obtaining the K_{APP} based on the APP-ID comprises deriving, by the AF, K_{APP} based the decrypted APP-ID.

16. The method of claim 13, wherein obtaining the K_{APP} based on the APP-ID comprises receiving, by the AF from a telecommunications network, K_{APP} calculated by the telecommunications network based on K_{AKMA}, AF-ID, and the decrypted APP-ID.

17. The method of claim 12, wherein obtaining the K_{APP} based on the APP-ID comprises:
sending the APP-ID to the telecommunications network; and
receiving, by the AF from a telecommunications network, K_{APP} calculated by the telecommunications network based on K_{AKMA}, AF-ID, and the APP-ID.

18-21. (canceled)

23. A network node implementing an Application Function, AF, for enabling Authentication and Key Management for Applications, AKMA, key diversity for multiple wireless device applications, the network node comprising:
one or more transmitters;
one or more receivers; and
processing circuitry associated with the one or more transmitters and the one or more receivers, the processing circuitry configured to cause the network node to:
receive, from an application of a wireless device, a session establishment request comprising an AKMA key identifier, A-KID, and an encrypted application identifier, APP-ID, encrypted using an AK key, K_{AF};
send, to a telecommunications network, a request for an AF key, K_{AF}, the request comprising A-KID;
obtain, from the telecommunications network, the K_{AF};
obtain an application key, K_{APP}, based on the K_{AF} and the APP-ID; and
execute an authentication protocol for the application using the K_{APP}.

24. (canceled)
